(19) United States
(12) Patent Application Publication
(10) Pub. No.: US 2026/0104719 A1
(43) Pub. Date: Apr. 16, 2026

(54) CONTROL DEVICE, MOBILE BODY, CONTROL METHOD, AND RECORDING MEDIUM

(71) Applicant: Panasonic Intellectual Property Management Co., Ltd., Osaka (JP)

(72) Inventors: Kazuma KITAZAWA, Osaka (JP); Sota MOROHASHI, Osaka (JP); Shohei IKEMURA, Kyoto (JP)

(21) Appl. No.: 19/421,513

(22) Filed: Dec. 16, 2025

Related U.S. Application Data
(63) Continuation of application No. PCT/JP2024/010681, filed on Mar. 19, 2024.

(30) Foreign Application Priority Data
Jul. 7, 2023 (JP) 2023-112604

(51) Int. Cl. G05D 1/698; G05D 1/695; G05D 105/22; G05D 109/10

(52) U.S. Cl. CPC G05D 1/6985; G05D 1/695; G05D 2105/24; G05D 2109/10

(57) ABSTRACT

A control device includes a controller that controls traveling of a first mobile body in a travel mode according to formation information, the travel mode including a convoy mode and a rotation mode. The convoy mode is a travel mode in which mobile bodies travel in a formation. The rotation mode is a travel mode that permits a leader to perform any type of traveling and permits a follower to perform only a rotation. When the formation information indicates that a first mobile body is the leader, the controller performs formation reorganization by causing all followers included in a formation to form, after the first mobile body moves from a lead position in the formation to an other position, a new formation in which the first mobile body that has moved to the other position is a new lead mobile body.

### CROSS REFERENCE TO RELATED APPLICATIONS

This is a continuation application of PCT International Application No. PCT/JP2024/010681 filed on March 19, 2024, designating the United States of America, which is based on and claims priority of Japanese Patent Application No. 2023-112604 filed on July 7, 2023. The entire disclosures of the above-identified applications, including the specifications, drawings and claims are incorporated herein by reference in their entirety.

### FIELD

The present disclosure relates to a control device that controls the traveling of a mobile body, a mobile body, a control method, and a recording medium.

### BACKGROUND

In recent years, mobile bodies such as robotic mobile bodies that are personal mobile bodies for which robot technology is used have been developed, and various techniques for supporting a user riding a mobile body have been proposed from various points of view (e.g., see Patent Literature (PTL) 1).

PTL 1 proposes a mobile body that enables a plurality of mobile bodies to travel in a formation on the same trajectory even when an obstacle is located on the travel path of the mobile body.

### Citation List

### Patent Literature

PTL 1: International Publication No. WO 2019/031168

### SUMMARY

### Technical Problem

However, the technique of PTL 1 is not capable of reorganizing a formation including a plurality of mobile bodies.

In view of this, the present disclosure provides a control device, a mobile body, a control method, and a recording medium that are capable of reorganizing a formation including a plurality of mobile bodies.

### Solution to Problem

In order to provide the above, a control device according to one aspect of the present disclosure is a control device that controls traveling of a first mobile body, and includes: a storage that stores formation information indicating whether the first mobile body is a leader or a follower, the leader being a lead mobile body among a plurality of mobile bodies traveling in a formation, the follower being a subsequent mobile body other than the lead mobile body among the plurality of mobile bodies traveling in the formation; and a controller that controls traveling of the first mobile body in a travel mode according to the formation information stored in the storage, the travel mode including a convoy mode and a rotation mode. The convoy mode is a travel mode in which the plurality of mobile bodies travel in a formation. The rotation mode is a travel mode that permits the leader to perform any of a plurality of types of traveling and permits the follower to perform only a rotation among the plurality of types of traveling. When the formation information indicates that the first mobile body is the leader, the controller performs formation reorganization by causing all followers included in a formation to form, after the first mobile body moves from a lead position in the formation to an other position, a new formation in which the first mobile body that has moved to the other position is a new lead mobile body.

In order to provide the above, a mobile body according to one aspect of the present disclosure includes the control device described above.

In order to provide the above, a control method according to one aspect of the present disclosure is a control method for controlling traveling of a first mobile body, and includes: reading out formation information from a storage, the formation information indicating whether the first mobile body is a leader or a follower, the leader being a lead mobile body among a plurality of mobile bodies traveling in a formation, the follower being a subsequent mobile body other than the lead mobile body among the plurality of mobile bodies traveling in the formation; and controlling traveling of the first mobile body in a travel mode according to the formation information read out, the travel mode including a convoy mode and a rotation mode. The convoy mode is a travel mode in which the plurality of mobile bodies travel in a formation. The rotation mode is a travel mode that permits the leader to perform any of a plurality of types of traveling and permits the follower to perform only a rotation among the plurality of types of traveling. In the controlling, when the formation information indicates that the first mobile body is the leader, formation reorganization is performed by causing all followers included in a formation to form, after the first mobile body moves from a lead position in the formation to an other position, a new formation in which the first mobile body that has moved to the other position is a new lead mobile body.

In order to provide the above, a recording medium according to one aspect of the present disclosure is a non-transitory computer-readable recording medium having recorded thereon a computer program for causing a computer to execute the control method described above.

### Advantageous Effects

The present disclosure provides a control device, a mobile body, a control method, and a recording medium that are capable of reorganizing a formation including a plurality of mobile bodies.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing the configurations of an input and output device and a mobile body.

FIG. 2 is a flow chart showing a control procedure for the mobile body performed by the input and output device according to an embodiment.

FIG. 3 is a state transition diagram showing the state of a travel mode displayed by the input and output device according to the embodiment.

FIG. 4 is a schematic diagram showing that users riding mobile bodies approach and appreciate an object.

FIG. 5 is a schematic diagram showing that the users riding the mobile bodies move on after appreciating the object after the state shown in (c) of FIG. 4.

FIG. 6 is a flow chart showing an example operation to switch the travel mode of a mobile body from a rotation mode to a convoy mode.

FIG. 7A is a schematic diagram showing examples of detailed movements in S51 shown in FIG. 6.

FIG. 7B is a schematic diagram showing examples of detailed movements in S52 to S54 shown in FIG. 6.

FIG. 8 is a flow chart showing another example operation to switch the travel mode of a mobile body from the rotation mode to the convoy mode.

FIG. 9A is a schematic diagram showing examples of detailed movements in S61 to S64 shown in FIG. 8.

FIG. 9B is a schematic diagram showing an example in which followers perform formation reorganization and the users riding the mobile bodies move on after the state shown in (c) of FIG. 9A.

FIG. 10 is a flow chart showing yet another example operation to switch the travel mode of a mobile body from the rotation mode to the convoy mode.

FIG. 11 is a schematic diagram showing examples of detailed movements in S71 to S73 shown in FIG. 10.

### DESCRIPTION OF EMBODIMENT

### Underlying Knowledge Acquired by the Inventors

When a plurality of users riding a plurality of mobile bodies appreciate or observe the same object in, for example, an art museum, moving in a determined formation is not necessarily efficient. For example, when the plurality of users move the plurality of mobile bodies in a direction different from the direction of travel of the plurality of mobile bodies after appreciating or observing the same object, the plurality of mobile bodies traveling in a formation need a longer travel path to change a direction of travel than a mobile body traveling alone.

For this reason, the inventors conducted intensive studies to find a method for causing a plurality of mobile bodies included in a formation to change a direction of travel more efficiently. As a result, the inventors conceived a way to change a direction of travel of a plurality of mobile bodies more efficiently by providing a control device that causes mobile bodies other than a leader to form, after the leader that is a lead mobile body among the plurality of mobile bodies moves from a lead position in a formation to an other position, a new formation in which the leader that has moved to the other position is a new lead mobile body, when users move the plurality of mobile devices in a direction different from the direction of travel of the plurality of mobile bodies.

More specifically, a control device according to a first aspect is a control device that controls traveling of a first mobile body, and includes: a storage that stores formation information indicating whether the first mobile body is a leader or a follower, the leader being a lead mobile body among a plurality of mobile bodies traveling in a formation, the follower being a subsequent mobile body other than the lead mobile body among the plurality of mobile bodies traveling in the formation; and a controller that controls traveling of the first mobile body in a travel mode according to the formation information stored in the storage, the travel mode including a convoy mode and a rotation mode. The convoy mode is a travel mode in which the plurality of mobile bodies travel in a formation. The rotation mode is a travel mode that permits the leader to perform any of a plurality of types of traveling and permits the follower to perform only a rotation among the plurality of types of traveling. When the formation information indicates that the first mobile body is the leader, the controller performs formation reorganization by causing all followers included in a formation to form, after the first mobile body moves from a lead position in the formation to an other position, a new formation in which the first mobile body that has moved to the other position is a new lead mobile body.

Accordingly, when the leader moves to the other position, the new formation in which the leader is the new lead mobile body is formed. For this reason, a more efficient change of the direction of travel of the plurality of mobile bodies is achieved.

In the control device according to a second aspect that is the control device according to the first aspect, the controller performs the formation reorganization in the rotation mode. Accordingly, since the formation reorganization is performed when the travel mode of the plurality of mobile bodies is the rotation mode, a smooth formation reorganization is achieved.

In the control device according to a third aspect that is the control device according to the first aspect or the second aspect, the other position is an end position in the new formation. Accordingly, after the mobile body that is the leader moves to the end position in the new formation, the formation is reorganized.

In the control device according to a fourth aspect that is the control device according to any one of the first aspect to the third aspect, in the formation reorganization, the controller performs orientation change control by causing all the followers included in the formation to become oriented in a direction of the first mobile body that has moved to the other position. Accordingly, in the formation reorganization, the controller makes it possible to perform the orientation change control by causing all the followers included in the formation to become oriented in the direction of the leader that has moved to the other position. For this reason, a more efficient change of the direction of travel of the plurality of mobile bodies is achieved without the users commanding the followers.

In the control device according to a fifth aspect that is the control device according to the fourth aspect, in the orientation change control, all the followers included in the formation become oriented in the direction of the first mobile body that has moved to the other position, by rotating by a predetermined angle. Accordingly, in the orientation change control, all the followers included in the formation become oriented in the direction of the leader that has moved to the other position, by rotating the predetermined angle. For this reason, a more efficient change of the direction of travel of the plurality of mobile bodies is achieved without the users commanding the followers.

In the control device according to a sixth aspect that is the control device according to the fourth aspect or the fifth aspect, in the orientation change control, all the followers included in the formation become oriented in the direction of the first mobile body that has moved to the other position, by rotating by an angle notified by the first mobile body. Accordingly, in the orientation change control, all the followers included in the formation become oriented in the direction of the leader that has moved to the other position, by rotating an angle notified by the leader. For this reason, a more efficient change of the direction of travel of the plurality of mobile bodies is achieved without the users commanding the followers.

In the control device according to a seventh aspect that is the control device according to any one of the fourth aspect to the sixth aspect, the controller performs the orientation change control in coordination with the first mobile body moving from the lead position in the formation to the other position in the formation reorganization. Accordingly, the controller makes it possible to perform the orientation change control by controlling all the followers in coordination with the leader moving from the lead position in the formation to the other position in the formation reorganization. For this reason, a more efficient change of the direction of travel of the plurality of mobile bodies is achieved without the users commanding the followers.

In the control device according to an eighth aspect that is the control device according to any one of the fourth aspect to the seventh aspect, in the orientation change control, all the followers included in the formation become oriented in the direction of the first mobile body that has moved to the other position, by detecting a position of the first mobile body that has moved to the other position. Accordingly, the followers rotate to become oriented in the direction of the leader, by detecting a position of the leader that has moved to the other position, without commands from the users riding the followers.

A mobile body according to a ninth aspect includes the control device according to any one of the first aspect to the eighth aspect. Accordingly, when the leader moves to the other position, the new formation in which the leader is the new lead mobile body is formed. For this reason, a more efficient change of the direction of travel of the plurality of mobile bodies is achieved.

A control method according to a tenth aspect is a control method for controlling traveling of a first mobile body, and includes: reading out formation information from a storage, the formation information indicating whether the first mobile body is a leader or a follower, the leader being a lead mobile body among a plurality of mobile bodies traveling in a formation, the follower being a subsequent mobile body other than the lead mobile body among the plurality of mobile bodies traveling in the formation; and controlling traveling of the first mobile body in a travel mode according to the formation information read out, the travel mode including a convoy mode and a rotation mode. The convoy mode is a travel mode in which the plurality of mobile bodies travel in a formation. The rotation mode is a travel mode that permits the leader to perform any of a plurality of types of traveling and permits the follower to perform only a rotation among the plurality of types of traveling. In the controlling, when the formation information indicates that the first mobile body is the leader, formation reorganization is performed by causing all followers included in a formation to form, after the first mobile body moves from a lead position in the formation to an other position, a new formation in which the first mobile body that has moved to the other position is a new lead mobile body. Accordingly, when the leader moves to the other position, the new formation in which the leader is the new lead mobile body is formed. For this reason, a more efficient change of the direction of travel of the plurality of mobile bodies is achieved.

A program according to an eleventh aspect causes a computer to execute the control method according to the tenth aspect. Accordingly, when the leader moves to the other position, the new formation in which the leader is the new lead mobile body is formed. For this reason, a more efficient change of the direction of travel of the plurality of mobile bodies is achieved.

### Embodiment

Hereinafter, an embodiment of the present disclosure is described in detail with reference to the Drawings. It should be noted that the embodiment described below shows a specific example of the present disclosure. The numerical values, constituent elements, the arrangement and connection of the constituent elements, steps, the order of steps, and display examples, etc. shown in the following embodiment are mere examples, and are not intended to limit the present disclosure. In addition, the figures each are not necessarily an accurate illustration. In each figure, the same reference signs are assigned to substantially identical constituent elements, and overlapping description is omitted or simplified.

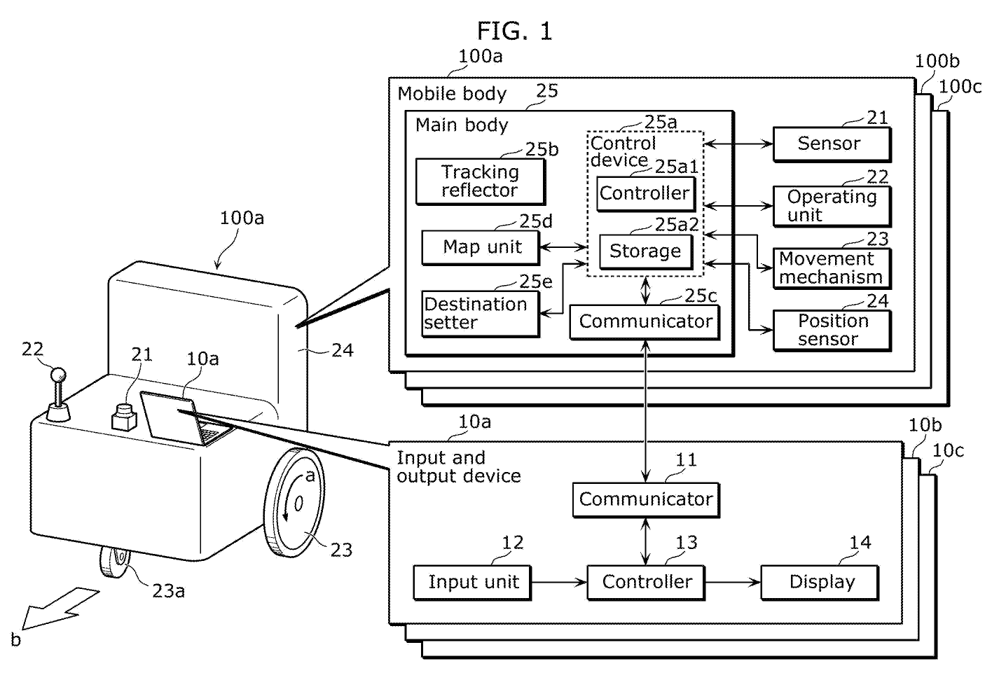

FIG. 1 is a block diagram showing the configurations of input and output device 10a and mobile body 100a. FIG. 1 also shows the external view of mobile body 100a. It should be noted that the figure shows input and output device 10a and mobile body 100a representatively among a plurality of input and output devices 10a to 10c and a plurality of mobile bodies 100a to 100c. Since the plurality of input output devices 10a to 10c and the plurality of mobile bodies 100a to 100c have identical configurations and functions, the following description focuses mainly on input and output device 10a and mobile body 100a representatively. Input output device 10a, input output device 10b, and input and output device 10c are associated with mobile body 100a, mobile body 100b, and mobile body 100c, respectively.

Input and output device 10a is an input and output device that transmits, to main body 25 of mobile body 100a, input information from a person riding mobile body 100a or a user operating mobile body 100a remotely, and displays a response result from main body 25 of mobile body 100a to the person riding mobile body 100a or the user operating mobile body 100a remotely. For example, input and output device 10a is a computer, a tablet terminal, or an information terminal such as a smartphone. Input and output device 10a may be fixed to mobile body 100a or held by a user riding mobile body 100a. Communication between input and output device 10a and mobile body 100a may be wired communication or wireless communication. Input and output device 10a includes communicator 11, input unit 12, controller 13, and display 14.

Communicator 11 is, for example, a wireless communication interface that communicates with controller 13 and main body 25 of mobile body 100a. Specifically, communicator 11 transmits information inputted to input unit 12 to main body 25 of mobile body 100a. In addition, communication 11 receives information about a response result from main body 25 of mobile body 100a.

Input unit 12 is, for example, a touch panel or a keyboard for the person riding mobile body 100a or the user operating mobile body 100a remotely to input information to input and output device 10a.

Controller 13 is a processor that executes a program for inputting and outputting data, by controlling communication 11, input unit 12, and display 14. For example, controller 13 causes communicator 11 to transmit the information inputted to input unit 12 to main body 25 of mobile body 100a, and causes display 14 to display the information inputted to input unit 12 and the response result from main body 25 of mobile body 100a. It should be noted that controller 13 may include memory that temporarily stores, for example, formation information about mobile body 100a.

Display 14 is, for example, a display that displays information inputted to input unit 12 and a response result from main body 25 of mobile body 100a.

Mobile body 100a is a vehicle that moves with a user on board. In the present embodiment, mobile body 100a is a robotic mobile body that includes both a manual driving function and an autonomous driving function. It should be noted that mobile body 100a need not always include the autonomous driving function. Mobile body 100a includes sensor 21, operating unit 22, movement mechanism 23, auxiliary wheel 23a, position sensor 24, and main body 25.

Sensor 21 is a sensor that detects obstacles or another mobile body for tracking, and is, for example, a Light Detection and Ranging (LiDAR) device, a laser range finder, or a camera. As long as sensor 21 makes it possible to detect obstacles or another mobile body, an installation of sensor 21 on mobile body 100a is not limited to just one position. In the present embodiment, sensor 21 is installed on a front portion of mobile body 100a in the direction of travel.

Operating unit 22 is, for example, an operating lever or a joystick used for steering or braking mobile body 100a. Steering is, for example, a command for a forward movement, a backward movement, and a rotation.

Movement mechanism 23 is a mechanism for driving mobile body 100a, and includes, for example, a battery, an inverter circuit, a motor, a pair of wheels installed on a rear lower portion of mobile body 100a, a steering mechanism, and a braking mechanism. By rotating in the direction indicated by arrow a shown on a wheel, the pair of wheels causes mobile body 100a to travel in the direction indicated by arrow b (the direction of travel). Moreover, the pair of wheels is driven, causing one of the wheels to rotate in the direction indicated by arrow a and an other of the wheels not to rotate. Mobile body 100a performs a pivot turn operation by each of the wheels being driven in a different manner.

Auxiliary wheel 23a is a wheel installed on a front lower portion of mobile body 100a. Auxiliary wheel 23a is installed on the front lower portion of mobile body 100a rotatably about an axis perpendicular to a travel surface.

Position sensor 24 is, for example, a magnetic sensor or an inertial measurement unit (IMU) that determines the direction of the nose of mobile body 100a. For example, when position sensor 24 is a magnetic sensor, position sensor 24 determines what compass direction the nose of mobile body 100a is pointing, based on an absolute angle. In addition, when position sensor 24 is an IMU, upon the user turning on mobile body 100a, position sensor 24 determines the direction of the nose of mobile body 100a as 0 degrees. In other words, position sensor 24 determines the direction of the nose of mobile body 100a, based on a relative angle. Angle information about the direction of the nose of mobile body 100a obtained by position sensor 24 is transmitted to main body 25. Additionally, position sensor 24 may determine the direction of the nose of mobile body 100a more accurately by coordinating the IMU and, for example, an encoder provided in the motor included in movement mechanism 23.

Main body 25 is the body of mobile body 100a and includes: auxiliary wheel 23a; control device 25a that controls movement mechanism 23; various types of structures (a frame and tracking reflector 25b); communicator 25; map unit 25d; and destination setter 25e.

Control device 25a includes controller 25a1 and storage 25a2. Control device 25a is, for example, a processor that executes a program stored in, for example, memory.

Controller 25a1 is a processor that executes a program for causing the travel mode of mobile body 100a to switch from the convoy mode to the rotation mode etc., and causing mobile body 100a to stop when an obstacle is located around mobile body 100a. Controller 25a1 causes mobile body 100a to stop, using an obstacle stop algorithm, for example, an A* algorithm. Specifically, controller 25a1 causes mobile body 100a to be driven manually or autonomously, by controlling movement mechanism 23 according to commands from input and output device 10a, sensor 21, operating unit 22, position sensor 24, map unit 25d, and destination setter 25e. It should be noted that a detailed description of the travel mode is provided later.

Storage 25a2 is, for example, memory that stores formation information about mobile body 100a, angle information about the direction of the nose of mobile body 100a obtained by position sensor 24, etc. Controller 25a1 reads out information from storage 25a2 and controls the traveling of mobile body 100a.

Tracking reflector 25b is a reflector installed on the rear portion of mobile body 100a. Sensor 21 detects laser reflected by tracking reflector 25b installed on the rear portion of a mobile body ahead. Accordingly, a mobile body tracks a mobile body ahead by detecting the mobile body ahead. For this reason, in the convoy mode, a follower makes it possible to track a mobile body ahead without requiring operations from a user.

Here, the travel mode of mobile body 100a is described. The travel mode includes, for example, a convoy mode and a rotation mode. The functions of the convoy mode and the rotation mode are described below. First, the convoy mode is a travel mode in which a plurality of mobile bodies travel in a formation. Specifically, a leader that is a lead mobile body in the formation travels according to a command from operating unit 22, and a follower that is a subsequent mobile body other than the lead mobile body tracks a mobile body ahead.

In contrast, the rotation mode is a travel mode that permits the leader to perform any of a plurality of types of traveling (a forward movement, a backward movement, and a rotation) and permits the follower to perform only the rotation among the plurality of types of traveling (the forward movement, the backward movement, and the rotation). Specifically, in the rotation mode, although the leader accepts an operation for the forward movement, the backward movement, and the rotation from operating unit 22, the follower accepts only an operation for the rotation from operating unit 22. Switching between the convoy mode and the rotation mode is described in detail later.

Communicator 25c is, for example, a wireless communication interface that communicates with communicator 11 of input and output device 10a, communicator 25c of mobile body 100b, and communicator 25c of mobile body 100c. Communicator 25c of mobile body 100a communicates with communicator 25c of mobile body 100b and communicator 25c of mobile body 100c and shares, for example, formation information and angle information. It should be noted that communicator 25c may include a plurality of communication modules or may be configured to perform transmission and reception in compliance with a plurality of communications standards. In particular, communicator 25c may be divided into: a communication module that communicates with other mobile bodies (desirably, a communication module switchable to a wireless connection hub mode when mobile body 100a is a leader, and a communication module switchable to a device connection mode when mobile body 100a is a follower); and a communication module that communicates with communicator 11.

Map unit 25d is a storage that stores map information about a space in which mobile body 100a travels. The map information may be two-dimensional spatial information or three-dimensional spatial information. Map unit 25d sets, to the map information, some destinations and travel path information for connecting the destinations. In other words, map unit 25d stores the travel path information about mobile body 100a. Each of the destinations set to the map information is assigned an individual destination number. In addition, map unit 25d sets a specific range of space as an area and stores map information.

Destination setter 25e is a processing unit that registers, as a travel destination of mobile body 100a, a specific position in map information stored in map unit 25d. Setting of each of destinations is performed by setting a corresponding destination number assigned to the destination.

Next, the characteristic operations of input and output device 10a and mobile body 100a thus configured according to the present embodiment are described.

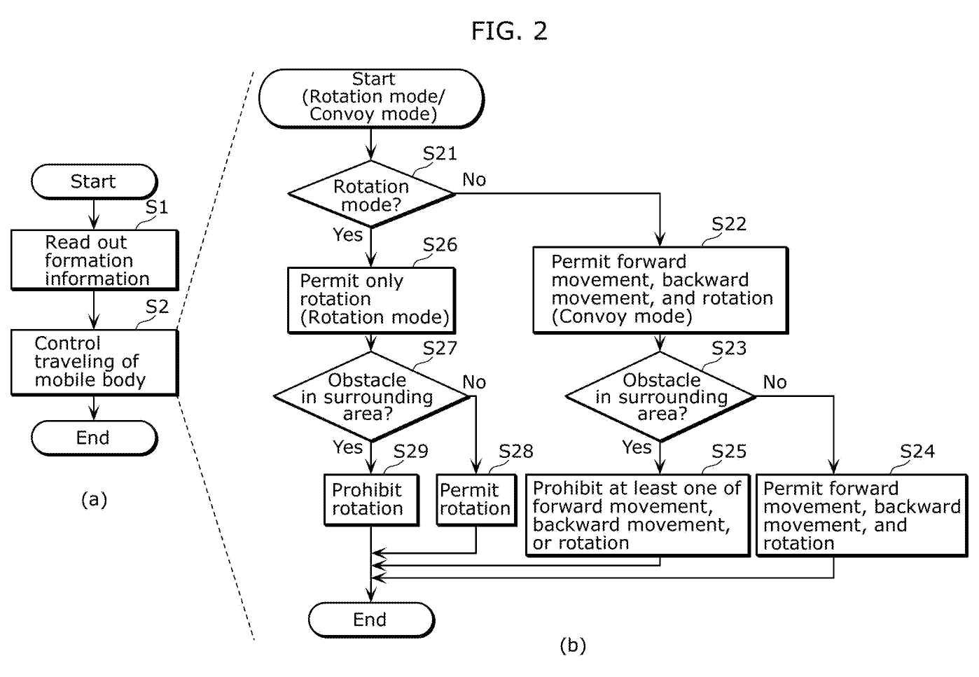

FIG. 2 is a flow chart showing a control procedure for mobile body 100a performed by input and output device 10a according to the embodiment. (a) of FIG. 2 is a flow chart showing a summary of the control procedure for mobile body 100a performed by input and output device 10a according to the embodiment. (b) of FIG. 2 is a flow chart showing a detailed control procedure in step S2.

As shown in (a) of FIG. 2, first, controller 25a1 reads out, from storage 25a2, formation information that indicates whether mobile body 100a is a leader or a follower, the leader being a lead mobile body among a plurality of mobile bodies traveling in a formation, the follower being a subsequent mobile body other than the lead mobile body among the plurality of mobile bodies traveling in the formation (step S1). It should be noted that when mobile body 100a is not in a formation, a person riding mobile body 100a or a user operating mobile body 100a remotely needs to set formation information that indicates whether mobile body 100a is a leader or a follower via input and output device 10a.

Next, controller 25a1 controls the traveling of mobile body 100a according to the formation information read out from storage 25a (step S2). The details of the controlling of the traveling are described with reference to (b) of FIG. 2.

As shown in (b) of FIG. 2, controller 25a1 determines whether the current travel mode of mobile body 100a is the convoy mode or the rotation mode (step S21).

In the case where the current travel mode of mobile body 100a is the convoy mode (No in S21), controller 25a1 permits movement mechanism 23 to perform a forward movement, a backward movement, and a rotation when the formation information read out indicates that mobile body 100a is the leader (step S22). Accordingly, mobile body 100a accepts an operation for the forward movement, the backward movement, and the rotation from operating unit 22. It should be noted that when the formation information read out indicates that mobile body 100a is the follower, an operation for the forward movement, the backward movement, and the rotation is not accepted from operating unit 22, and only autonomous tracking is performed by mobile body 100a.

Additionally, controller 25a1 determines whether an obstacle is located around mobile body 100a (step S23).

In the case where the obstacle is not located around mobile body 100a (No in step S23), controller 25a1 permits mobile body 100a to perform the forward movement, the backward movement, and the rotation when the formation information read out indicates that mobile body 100a is the leader (step S24). It should be noted that controller 25a1 permits mobile body 100a to perform only the autonomous tracking when the formation information read out indicates that mobile body 100a is the follower.

In the case where the obstacle is located around mobile body 100a (Yes in step S23), controller 25a1 prohibits mobile body 100a from performing at least one of the forward movement, the backward movement, or the rotation when the formation information read out indicates that mobile body 100a is the leader (step S25). Controller 25a1 may determine to prohibit one or more of the forward movement, the backward movement, and the rotation according to a direction in which the obstacle is located. It should be noted that controller 25a1 prohibits mobile body 100a from performing the autonomous tracking and causes mobile body 100a to stop when the formation information read out indicates that mobile body 100a is the follower.

On the other hand, in the case where the current travel mode of mobile body 100a is the rotation mode (Yes in step S21), controller 25a1 permits movement mechanism 23 to perform only the rotation when the formation information read out indicates that mobile body 100a is the follower (step S26). Accordingly, mobile body 100a accepts an operation for only the rotation from operating unit 22. It should be noted that mobile body 100a accepts an operation for the forward movement, the backward movement, and the rotation from operating unit 22 when the formation information read out indicates that mobile body 100a is the leader.

Additionally, controller 25a1 determines whether an obstacle is located around mobile body 100a (step S27).

In the case where the obstacle is not located around mobile body 100a (No in step S27), controller 25a1 permits mobile body 100a to perform the rotation when the formation information read out indicates that mobile body 100a is the follower (step S28). It should be noted that controller 25a1 permits mobile body 100a to perform the forward movement, the backward movement, and the rotation when the formation information read out indicates that mobile body 100a is the leader.

On the other hand, in the case where the obstacle is located around mobile body 100a (Yes in step S27), controller 25a1 prohibits mobile body 100a from performing the rotation when the formation information read out indicates that mobile body 100a is the follower (step S29). It should be noted that controller 25a1 may prohibit mobile body 100a from performing not only the rotation but also at least one of the forward movement, the backward movement, or the rotation according to a direction in which the obstacle is located, when the formation information read out indicates that mobile body 100a is the leader.

A mobile body makes it possible to rotate according to a command from an operating device. Accordingly, the user riding the mobile body can control a desired rotation by operating the operating device.

A follower makes it possible to automatically avoid colliding with an obstacle. Accordingly, the user can ride the mobile body comfortably.

In order that mobile bodies avoid colliding with each other in the case where one of the mobile bodies rotates, when the travel mode of mobile body 100a is the convoy mode, mobile body 100a may stop at a distance from a mobile body ahead. In addition, when mobile body 100a approaches the vicinity of a destination (e.g., an object) stored in map unit 25d or enters a specific range of space stored in map unit 25d, mobile body 100a may stop at a distance from a mobile body ahead. Accordingly, even when mobile body 100a rotates, mobile body 100a makes it possible to avoid colliding with another mobile body.

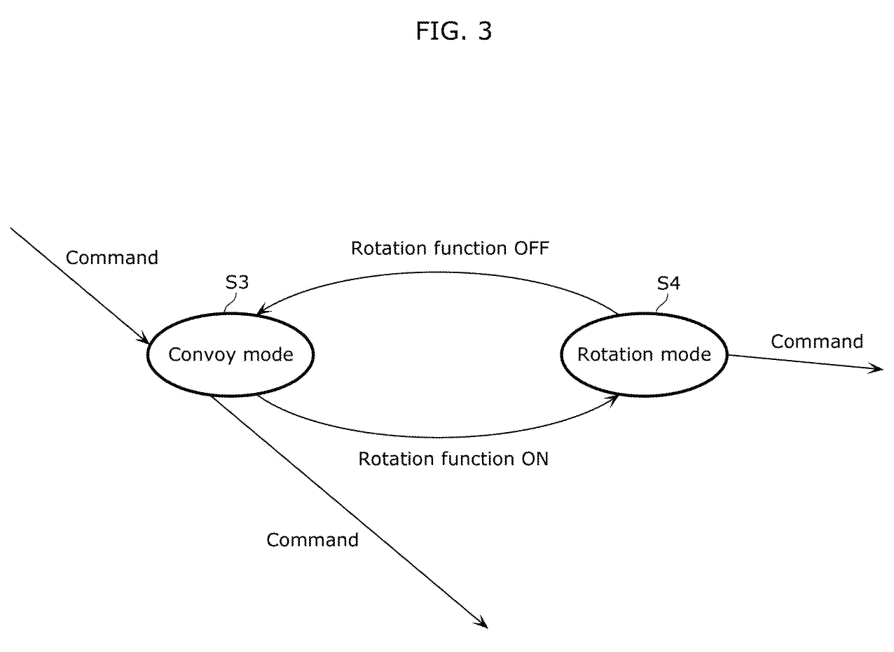

FIG. 3 is a state transition diagram showing the state of a travel mode displayed by input and output device 10a according to the embodiment.

As shown in FIG. 3, by a person riding mobile body 100a or a user operating mobile body 100a remotely commanding input and output device 10a, controller 25a1 sets the travel mode of mobile body 100a to convoy mode S3. Specifically, the person riding mobile body 100a or the user operating mobile body 100a remotely selects the convoy mode on a mode selection screen displayed on display 14 (i.e., makes a selection using input unit 12). Then, controller 13 transmits the command for selecting the convoy mode to main body 25, and controller 25a1 switches the travel mode of mobile body 100a from another travel mode to the convoy mode.

In the case where the travel mode of mobile body 100a is convoy mode S3 and the formation information read out by controller 25a1 indicates that mobile body 100a is a leader, when the person riding mobile body 100a or the user operating mobile body 100a remotely presses rotation function OFF (i.e., input unit 12) displayed on display 14 of input and output device 10a, rotation function ON is displayed on display 14, and controller 25a1 switches the travel mode of mobile body 100a from convoy mode S3 to rotation mode S4. Additionally, when the travel mode of mobile body 100a is convoy mode S3 and the formation information read out by controller 25a1 indicates that mobile body 100a is a follower, the person riding mobile body 100a can press a rotation mode request button displayed on display 14 of input and output device 10a. The rotation mode request is displayed on display 14 of an input and output device (e.g., input and output device 10b or 10c) that coordinates with a leader, by the person riding mobile body 100a pressing the rotation mode request button. Accordingly, a person riding the leader or a user operating the leader remotely can find out a demand of a person riding a follower for appreciating an exhibit, and switch the travel mode of each of the leader and the follower from the convoy mode to the rotation mode.

In the case where the travel mode of mobile body 100a is rotation mode S4 and the formation information read out by controller 25a1 indicates that mobile body 100a is a leader, when the person riding mobile body 100a or the user operating mobile body 100a remotely presses rotation function ON (i.e., input unit 12) displayed on display 14 of input and output device 10a, rotation function OFF is displayed on display 14, and controller 25a1 switches the travel mode of mobile body 100a from rotation mode S4 to convoy mode S3. Additionally, when the travel mode of mobile body 100a is rotation mode S4 and the formation information read out by controller 25a1 indicates that mobile body 100a is a follower, the person riding mobile body 100a can press a convoy mode request button displayed on display 14 of input and output device 10a. The convoy mode request is displayed on display 14 of an input and output device (e.g., input and output device 10b or 10c) that coordinates with a leader, by the person riding mobile body 100a pressing the convoy mode request button. Accordingly, a person riding the leader or a user operating the leader remotely can find out a demand of a person riding a follower for appreciating the next exhibit, and switch the travel mode of each of the leader and the follower from the rotation mode to the convoy mode.

Even when the travel mode of mobile body 100a is convoy mode S3 or rotation mode S4, by commanding input and output device 10a, the travel mode of mobile body 100a makes it possible to exit convoy mode S3 or rotation mode S4. Specifically, when the formation information read out by controller 25a1 indicates that mobile body 100a is a leader, by the person riding mobile body 100a or the user operating mobile body 100a remotely transmitting a command on the mode selection screen displayed on display 14 of input and output device 10a (i.e., transmitting a command using input unit 12), the travel mode of mobile body 100a makes it possible to exit convoy mode S3 or rotation mode S4. Moreover, when the formation information read out by controller 25a1 indicates that mobile body 100a is a follower, by the person riding mobile body 100a transmitting a command on the mode selection screen displayed on display 124 of input and output device 10a (i.e., transmitting a command using input unit 12), the travel mode of mobile body 100a makes it possible to exit convoy mode S3 or rotation mode S4, and the travel mode of another mobile body makes it possible to remain convoy mode S3 or rotation mode S4. Furthermore, when mobile body 100a is not in a formation, by the person riding mobile body 100a transmitting a command on the mode selection screen displayed on display 14 of input and output device 10a (i.e., transmitting a command using input unit 12), mobile body 100a becomes a follower in a formation and the travel mode of mobile body 100a is switched to convoy mode S3.

It should be noted that, to switch the travel mode of mobile body 100a to the rotation mode, the travel mode of mobile body 100a always needs to be the convoy mode, and it is impossible to switch another travel mode to the rotation mode.

Accordingly, by merely switching the rotation mode between on and off, the user can switch the travel mode of mobile body 100a between the convoy mode and the rotation mode.

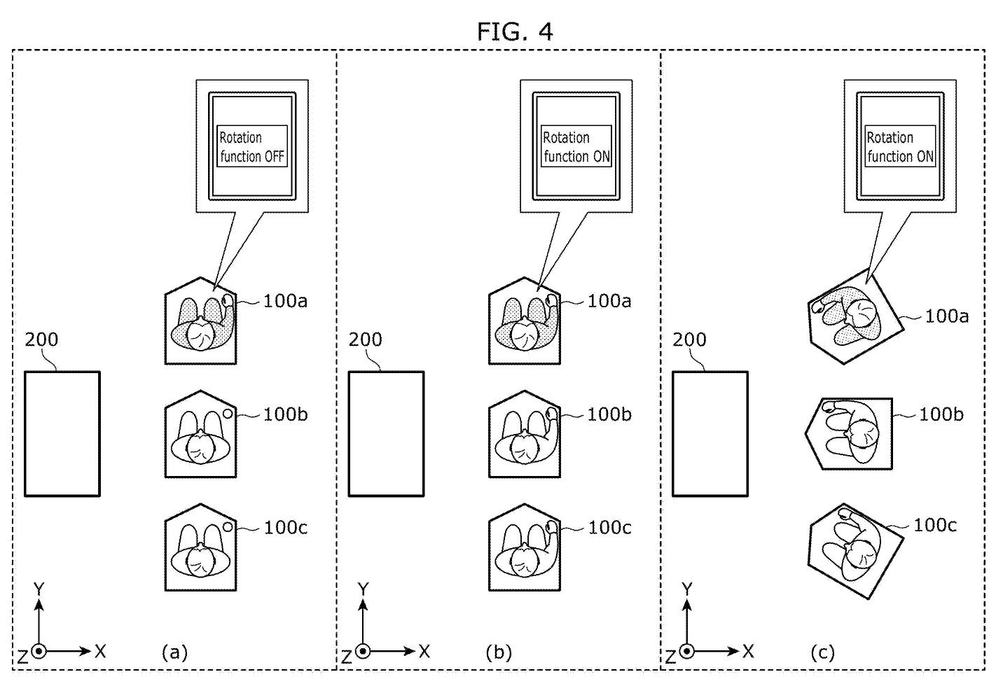

FIG. 4 is a schematic diagram showing users riding mobile bodies 100a to 100c approach and appreciate object 200. FIG. 4 is a schematic diagram viewed from above. Mobile bodies 100a to 100c shown in FIG. 4 are shaped like a pentagon with an arrow-like point to clearly show the direction of travel of mobile bodies 100a to 100c. (a) of FIG. 4 is a schematic diagram showing a state in which mobile bodies 100a to 100c travel to object 200 in the convoy mode. (b) of FIG. 4 is a schematic diagram showing a state in which the travel mode of mobile bodies 100a to 100c is switched from the convoy mode to the rotation mode. (c) of FIG. 4 is a schematic diagram showing that the users operate mobile bodies 100a to 100c to rotate and become oriented in the direction of object 200. It should be noted that mobile body 100a is a leader and mobile bodies 100b and 100c are followers.

First, as shown in (a) of FIG. 4, mobile bodies 100a to 100c ridden by the users move sideways to object 200 in the convoy mode. In the present embodiment, a formation of mobile bodies 100a to 100c in the convoy mode moves in the order in which mobile body 100a, mobile body 100b, and mobile body 100c are arranged with mobile body 100a as the lead. Mobile bodies 100a to 100c are oriented in a positive direction along the Y axis and do not stop face-to-face with object 200 (i.e., oriented sideways).

Next, as shown in (b) of FIG. 4, the user switches rotation function OFF to rotation function ON. For example, by pressing a button (i.e., input unit 12) displayed on display 14, the user switches rotation function OFF to rotation function ON. This operation causes the travel mode of mobile bodies 100a to 100c to switch from the convoy mode to the rotation mode. It should be noted that an operation to switch rotation function OFF to rotation function ON may be performed by the user riding the leader or the users riding the followers, or a user riding none of the mobile bodies and located at a remote place.

Finally, as shown in (c) of FIG. 4, by the users riding mobile bodies 100a to 100c inputting commands via respective operating units 22, mobile bodies 100a to 100c rotate (e.g., perform a pivot turn operation in which one of the two drive wheels is stopped and the other of the two drive wheels is rotated) according to the commands from respective operating units 22. At this time, when respective main bodies 25 detect obstacles around mobile bodies 100a to 100c, respective main bodies 25 cause mobile bodies 100a to 100c to perform an operation to avoid colliding with the obstacles. Specifically, respective main bodies 25 prohibit mobile bodies 100a to 100c from rotating. It should be noted that controller 25a1 causes mobile body 100a to perform a forward movement, a backward movement, and a rotation according to the command from operating unit 22, and respective controllers 25a1 cause mobile bodies 100b and 100c to perform only the rotation according to the commands from respective operating units 22.

Accordingly, since a controller makes it possible to switch the travel mode of a mobile body which a user is riding from the convoy mode to the rotation mode when users riding mobile bodies appreciate or observe the same object in, for example, an art museum, the user can orient the nose of the mobile body in the direction of the object temporarily. For this reason, the user need not orient only the posture of the user in the direction of the object while maintaining the lateral orientation of the mobile body. As a result, it is possible to reduce the burden on the user.

In addition, the mobile body makes it possible to rotate according to a command from an operating device. Accordingly, the user riding the mobile body can control a desired rotation by operating the operating device.

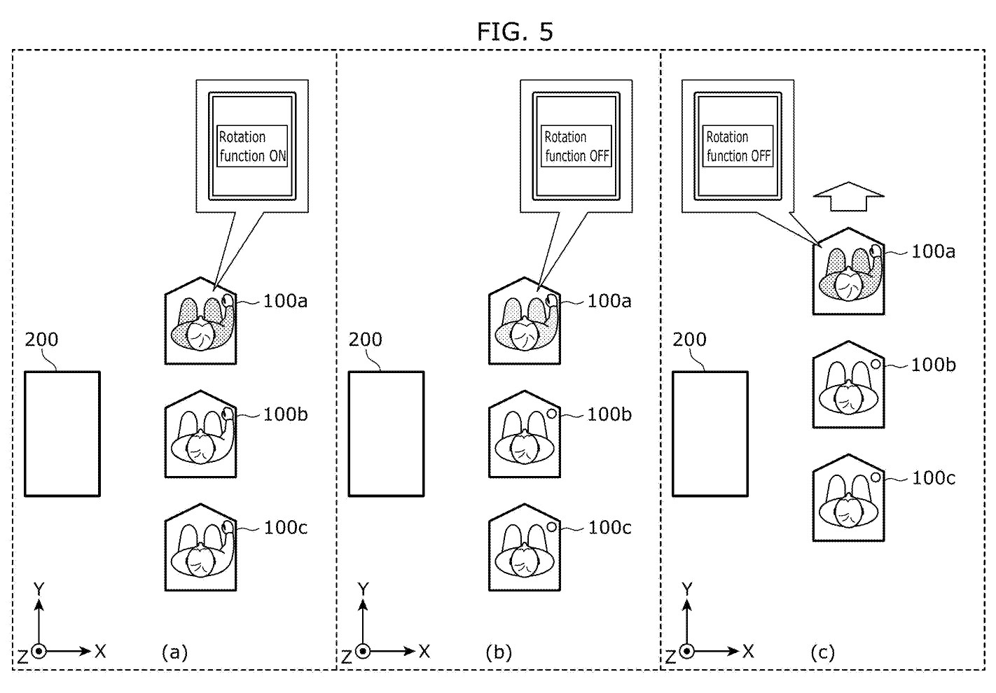

FIG. 5 is a schematic diagram showing that the users riding mobile bodies 100a to 100c move on after appreciating object 200 after the state shown in (c) of FIG. 4. (a) of FIG. 5 is a schematic diagram showing that mobile bodies 100a to 100c rotate and are oriented in the positive direction along the Y axis. (b) of FIG. 5 is a schematic diagram showing a state in which the travel mode of mobile bodies 100a to 100c is switched from the rotation mode to the convoy mode. (c) of FIG. 5 is a schematic diagram showing that mobile bodies 100a to 100c travel in the convoy mode and move away from object 200.

First, as shown in (a) of FIG. 5, by the respective users riding mobile bodies 100a to 100c inputting commands via respective operating units 22, mobile bodies 100a to 100c rotate in the direction along the Y axis (e.g., perform a pivot turn operation) according to the commands from respective operating units 22. At this time, as with (c) of FIG. 4, when respective main bodies 25 detect obstacles around mobile bodies 100a to 100c, respective main bodies 25 cause mobile bodies 100a to 100c to avoid colliding with the obstacles. It should be noted that mobile bodies 100a to 100c need not be precisely oriented in the positive direction along the Y axis, and may be substantially oriented in the positive direction along the Y axis. Specifically, mobile bodies 100a to 100c may rotate in order that sensor 21 of a mobile body behind recognizes tracking reflector 25b installed on a mobile body ahead.

Next, as shown in (b) of FIG. 5, the user switches rotation function ON to rotation function OFF. For example, by pressing a button (i.e., input unit 12) displayed on display 14, the user switches rotation function ON to rotation function OFF. This operation causes the travel mode of mobile bodies 100a to 100c to switch from the rotation mode to the convoy mode. It should be noted that an operation to switch rotation function ON to rotation function OFF may be performed by the user riding the leader or the user riding the follower, or a user riding none of the mobile bodies and located at a remote place.

Finally, as shown in (c) of FIG. 5, by the user riding mobile body 100a inputting a command via operating unit 22, mobile bodies 100a to 100c travel in the convoy mode and move away from object 200.

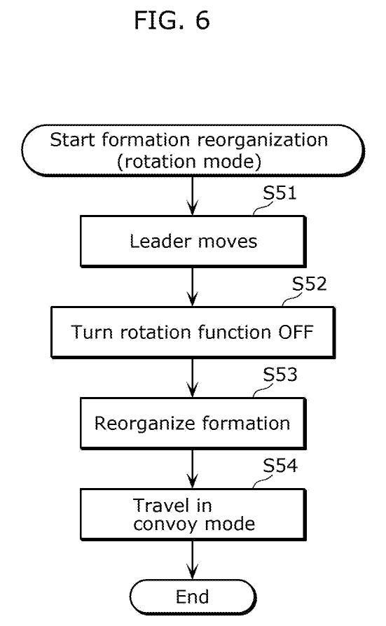

FIG. 6 is a flow chart showing an example operation to switch the travel mode of a mobile body from the rotation mode to the convoy mode. FIG. 6 is a flow chart on the premise of the movements of a plurality of mobile bodies.

As shown in FIG. 6, first, a mobile body that is a leader moves from the lead position in a formation to an other position (step S51).

Next, a user turns the rotation function of a plurality of mobile bodies OFF (step S52). This causes the travel mode of the plurality of mobile bodies to switch from the rotation mode to the convoy mode. Then, controller 25a1 performs formation reorganization by causing all followers included in the formation to form a new formation in which the leader that has moved to the other position is a new lead mobile body (step S53).

After the formation reorganization is performed, the plurality of mobile bodies travel in the convoy mode (step S54).

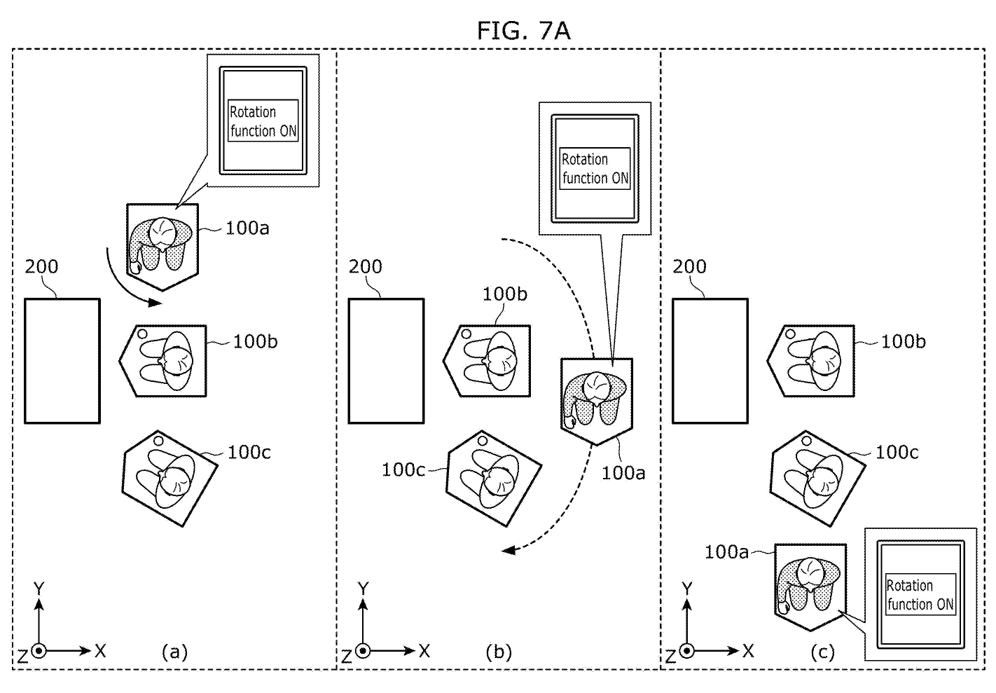

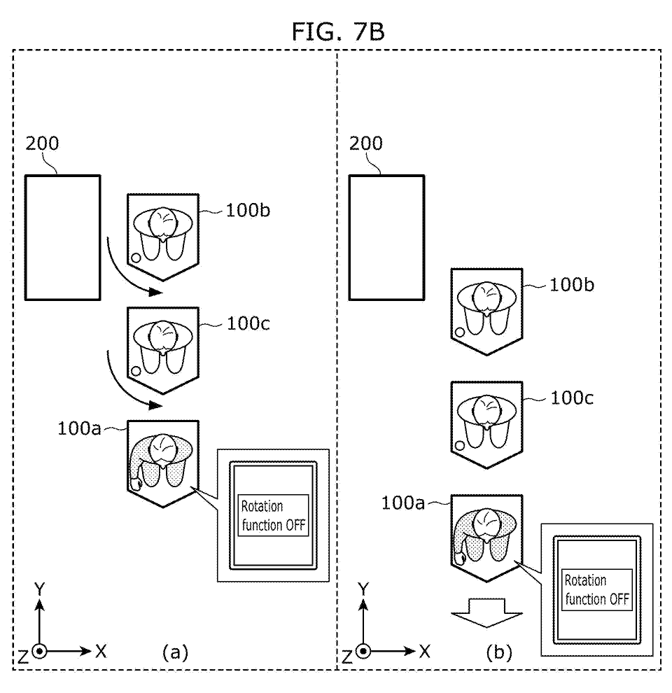

FIG. 7A is a schematic diagram showing examples of detailed movements in S51 shown in FIG. 6. FIG. 7A is a schematic diagram showing the movements of mobile body 100a after the state shown in (c) of FIG. 4. The figure shows an example operation to reorganize a formation that has entered the art museum in the positive direction along the Y axis into a new formation for exiting the art museum in an opposite direction (a negative direction along the Y axis) after appreciation. (a) of FIG. 7A is a schematic diagram showing that mobile body 100a rotates to change the orientation of mobile body 100a from object 200 to mobile body 100b. (b) of FIG. 7A is a schematic diagram showing that mobile body 100a moves from the lead position in the formation to the other position. (c) of FIG. 7A is a schematic diagram showing that mobile body 100a moves to the end position in the new formation.

First, as shown in (a) of FIG. 7A, by inputting a command via operating unit 22, the user riding mobile body 100a causes mobile body 100a to rotate (e.g., perform a pivot turn operation) to change the orientation of mobile body 100a from object 200 to mobile body 100b. This rotation of mobile body 100a is intended to help mobile body 100a to move from the lead position in the formation to the other position. Accordingly, mobile body 100a need not always rotate to become oriented in the direction of mobile body 100b.

Next, as shown in (b) of FIG. 7A, by inputting a command via operating unit 22, the user riding mobile body 100a causes mobile body 100a to move from the lead position in the formation to the other position.

Finally, as shown in (c) of FIG. 7A, mobile body 100a moves to the end position in the new formation. It should be noted that an other position to which mobile body 100a moves from the lead position in a formation is not limited to the end position in the new formation, and may be a position other than the end position in the new formation.

Accordingly, after a mobile body that is a leader moves to the end position in a new formation, the formation is reorganized.

FIG. 7B is a schematic diagram showing examples of detailed movements in S52 to S54 shown in FIG. 6. (a) of FIG. 7B is a schematic diagram when the user turns the rotation function button displayed on display 14 OFF after the state shown in (c) of FIG. 7A. (b) of FIG. 7B is a schematic diagram showing that after the formation reorganization is performed, mobile bodies 100a to 100c travel in the convoy mode and move away from object 200.

First, as shown in (a) of FIG. 7B, the user switches rotation function ON to rotation function OFF. For example, by pressing a button (i.e., input unit 12) displayed on display 14, the user switches rotation function ON to rotation function OFF. Then, controller 25a1 causes mobile bodies 100b and 100c to form a formation (perform formation reorganization) in which mobile body 100a that has moved to the other position is a new lead mobile body. In other words, all the followers rotate (e.g., perform a pivot turn operation) to form a formation in which the leader that has moved to the other position is a new lead mobile body. This formation reorganization changes the order in which the followers are arranged in the formation. Specifically, although mobile body 100a, mobile body 100b, and mobile body 100c are arranged in stated order with mobile body 100a as the lead before the formation reorganization, mobile body 100a, mobile body 100c, and mobile body 100b are arranged in stated order with mobile body 100a as the lead after the formation reorganization It should be noted that an operation to switch rotation function ON to rotation function OFF may be performed by the user riding the leader or a user riding none of the mobile bodies and located at a remote place.

Hereinafter, the rotations of mobile bodies 100b and 100c are described in detail. Storage 25a2 stores angle information obtained by position sensor 24. To put it another way, storage 25a2 stores the direction of the nose of mobile body 100a. Accordingly, by causing mobile body 100b and mobile body 100c to rotate in line with the direction of the nose of mobile body 100a, controller 25a1 of mobile body 100b and controller 25a1 of mobile body 100c make it possible to form a formation (perform formation reorganization) in which mobile body 100a is a new lead mobile body. It is conceivable to use, for example, an absolute angle in determining rotation angles of mobile bodies 100b and 100c. When position sensor 24 is a magnetic sensor, position sensor 24 recognizes angle information indicating the directions of the noses of mobile bodies 100b and 100c, based on an absolute angle, and storage 25a2 stores the angle information. Accordingly, controller 25a1 of mobile body 100b and controller 25a1 of mobile body 100c command mobile bodies 100b and 100c to rotate to become oriented in the same direction as the nose of mobile body 100a, respectively. As another method, it is conceivable to use, for example, relative angles in determining rotation angles of mobile bodies 100b and 100c. When position sensor 24 is an IMU, position sensor 24 recognizes angle information indicating the directions of the noses of mobile bodies 100b and 100c, based on relative angles, and storage 25a2 stores the angle information. Controller 25a1 of mobile body 100b and controller 25a1 of mobile body 100c calculate a difference between relative angles indicating the directions of the noses of mobile bodies 100b and 100c and a relative angle indicating the direction of the nose of mobile body 100a. Accordingly, controller 25a1 of mobile body 100b and controller 25a1 of mobile body 100c command mobile bodies 100b and 100c to rotate by an angle corresponding to the difference.

Moreover, as still another method, rotation angles of mobile bodies 100b and 100c may be predetermined angles. When sensors 21 of mobile bodies 100b and 100c recognize tracking reflector 25b of a mobile body ahead, mobile bodies 100b and 100c form a formation (perform formation reorganization) in which mobile body 100a that has moved to the other position is a new lead mobile body. For example, when a travel route is set in an art museum, rotation angles of mobile bodies 100b and 100c may be predetermined angles because directions in which mobile bodies are oriented are determined in advance.

Furthermore, mobile bodies 100b and 100c may recognize a position of mobile body 100a and rotate. For example, position sensor 24 recognizes not angle information about a mobile body but position information. Accordingly, storage 25a2 of mobile body 100b and storage 25a2 of mobile body 100c store position information about mobile bodies 100a to 100c. Controller 25a1 of mobile body 100b and controller 25a1 of mobile body 100c command mobile bodies 100b and 100c to rotate to become oriented in a direction in which mobile body 100a is located, by referring to storage 25a2 of mobile body 100b and storage 25a2 of mobile body 100c, respectively.

Next, as shown in (b) of FIG. 7B, after the formation reorganization is performed, by the user riding mobile body 100a inputting a command via operating unit 22, mobile bodies 100a to 100c travel in the convoy mode and move away from object 200.

Accordingly, when only the leader moves to the other position, a new formation in which the leader is a new lead device is formed. For this reason, a more efficient change of the direction of travel of the mobile bodies is achieved.

Moreover, in the formation reorganization, controller 25a1 makes it possible to perform orientation change control by causing all the followers included in the formation to become oriented in a direction of the leader that has moved to the other position. For this reason, a more efficient change of the direction of travel of the mobile bodies is achieved without the users commanding the followers.

Furthermore, in the orientation change control, all the followers included in the formation become oriented in the direction of the leader that has moved to the other position, by rotating by an angle notified by the leader. For this reason, a more efficient change of the direction of travel of the mobile bodies is achieved without the users commanding the followers.

In addition, even when the users riding the followers do not command the followers, the followers rotate to become oriented in the direction of the leader, by detecting a position of the leader that has moved to the other position.

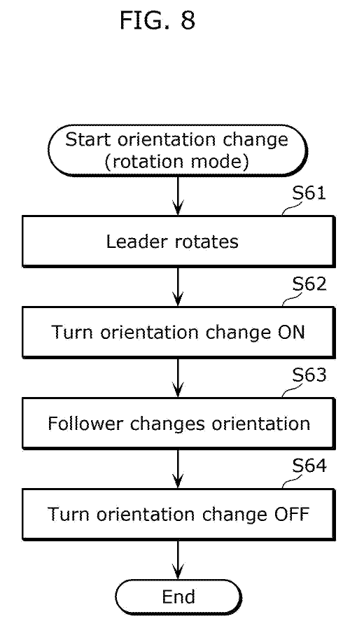

FIG. 8 is a flow chart showing another example operation to switch the travel mode of a mobile body from the rotation mode to the convoy mode. FIG. 8 is a flow chart on the premise of the movements of a plurality of mobile bodies in the same manner as FIG. 6.

As shown in FIG. 8, first, by inputting a command via operating unit 22, a user riding a leader that is a mobile body causes the leader to rotate to become oriented in a direction in which the leader travels next (step S61).

Next, the user turns an orientation change button (i.e., input unit 12) displayed on display 14 ON (step S62). Then, a follower rotates in line with a direction of the nose of the leader (step S63).

After that, the user turns the orientation change button (i.e., input unit 12) displayed on display 14 OFF (step S64).

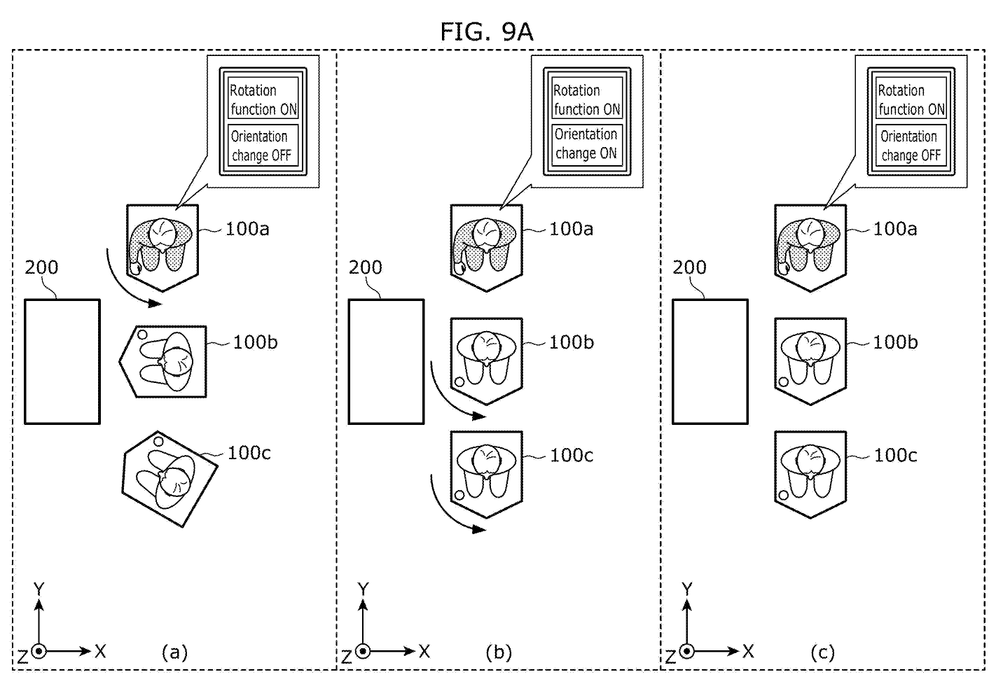

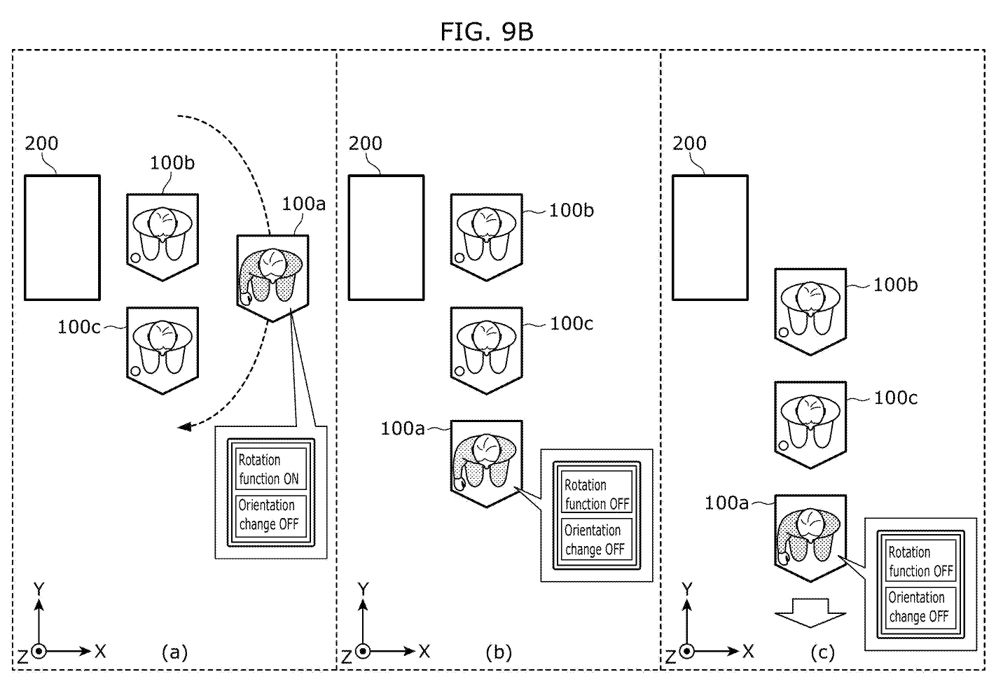

FIG. 9A is a schematic diagram showing examples of detailed movements in S61 to S64 shown in FIG. 8. The figure shows another example operation to reorganize a formation that has entered the art museum in the positive direction along the Y axis into a new formation for exiting the art museum in the opposite direction (the negative direction along the Y axis) after appreciation. (a) of FIG. 9A is a schematic diagram showing that mobile body 100a rotates to become oriented in a direction in which mobile body 100a travels next after the state shown in (c) of FIG. 4. (b) of FIG. 9A is a schematic diagram showing that by the user turning the orientation change button displayed on display 14 ON, mobile bodies 100b and 100c are caused to rotate to become oriented in the direction of mobile body 100a. (c) of FIG. 9A is a schematic diagram when the user turns the orientation change button displayed on display 14 OFF.

First, as shown in (a) of FIG. 9A, by inputting a command via operating unit 22, the user riding mobile body 100a causes mobile body 100a to rotate (e.g., perform a pivot turn operation) to become oriented in a direction in which mobile body 100a travels next.

Next, as shown in (b) of FIG. 9A, the user switches orientation change OFF to orientation change ON. For example, by pressing the orientation change button (i.e., input unit 12) displayed on display 14, the user switches orientation change OFF to orientation change ON. This operation causes mobile bodies 100b and 100c to rotate (e.g., perform a pivot turn operation) in line with the direction of the nose of mobile body 100a. Rotation angles of mobile bodies 100b and 100c may be determined using the absolute angle and the relative angles described in (a) of FIG. 7B or may be determined based on predetermined angles. It should be noted that an operation to switch between orientation change OFF and orientation change ON may be performed by the user riding the leader or a user riding none of the mobile bodies and located at a remote place.

Finally, as shown in (c) of FIG. 9A, by pressing the orientation change button displayed on display 14, the user switches orientation change ON to orientation change OFF. This operation causes mobile bodies 100b and 100c to stop rotating in line with the direction of the nose of mobile body 100a.

Accordingly, since the formation reorganization is performed when the travel mode of the mobile bodies is the rotation mode, a smooth formation reorganization is achieved.

Moreover, in the formation reorganization, controller 25a1 makes it possible to perform orientation change control by causing all the followers included in the formation to become oriented in a direction of the leader that has moved to the other position. For this reason, a more efficient change of the direction of travel of the mobile bodies is achieved without the users commanding the followers.

Furthermore, in the orientation change control, all the followers included in the formation become oriented in the direction of the leader that has moved to the other position, by rotating by a predetermined angle. For this reason, a more efficient change of the direction of travel of the mobile bodies is achieved without the users commanding the followers.

Additionally, in the orientation change control, all the followers included in the formation become oriented in the direction of the leader that has moved to the other position, by rotating by an angle notified by the leader. For this reason, a more efficient change of the direction of travel of the mobile bodies is achieved without the users commanding the followers.

FIG. 9B is a schematic diagram showing an example in which the followers perform formation reorganization and the users riding mobile bodies 100a to 100c move away from object 200 after the state shown in (c) of FIG. 9A. (a) of FIG. 9B is a schematic diagram showing that mobile body 100a moves from the lead position to the end position in the new formation. (b) of FIG. 9B is a schematic diagram showing that by the user turning a rotation function button displayed on display 14 OFF, mobile bodies 100b and 100c are caused to perform formation reorganization. (c) of FIG. 9B is a schematic diagram showing that after the formation reorganization is performed, mobile bodies 100a to 100c travel in the convoy mode and move away from object 200.

First, as shown in (a) of FIG. 9B, by the user riding mobile body 100a inputting a command via operating unit 22, mobile body 100a is caused to move from the lead position to the end position in the new formation.

Next, as shown in (b) of FIG. 9B, the user switches rotation function ON to rotation function OFF. For example, by pressing a button (i.e., input unit 12) displayed on display 14, the user switches rotation function ON to rotation function OFF. Then, controller 25a1 causes mobile bodies 100b and 100c to form a formation (perform formation reorganization) in which mobile body 100a that has moved to the other position is a new lead mobile body. This formation reorganization changes the order in which the followers are arranged in the formation. Specifically, although mobile body 100a, mobile body 100b, and mobile body 100c are arranged in stated order with mobile body 100a as the lead before the formation reorganization, mobile body 100a, mobile body 100c, and mobile body 100b are arranged in stated order with mobile body 100a as the lead after the formation reorganization It should be noted that an operation to switch rotation function ON to rotation function OFF may be performed by the user riding the leader or a user riding none of the mobile bodies and located at a remote place.

Finally, as shown in (c) of FIG. 9B, by the user riding mobile body 100a inputting a command via operating unit 22, mobile bodies 100a to 100c travel in the convoy mode and move away from object 200.

Accordingly, when only the leader moves to the other position, a new formation in which the leader is a new lead device is formed. For this reason, a more efficient change of the direction of travel of the mobile bodies is achieved.

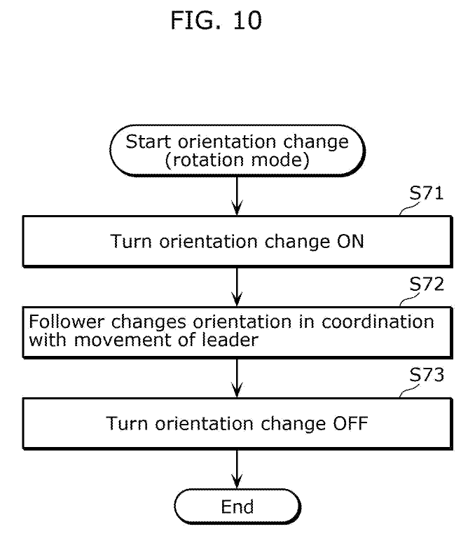

FIG. 10 is a flow chart showing yet another example operation to switch the travel mode of a mobile body from the rotation mode to the convoy mode. FIG. 10 is a flow chart on the premise of the movements of a plurality of mobile bodies in the same manner as FIG. 6 and FIG. 8.

First, a user turns an orientation change button (i.e., input unit 12) displayed on display 14 ON (step S71).

Next, by inputting a command via operating unit 22, the user riding a leader that is a mobile body causes the leader to move to an other position. Then, a follower rotates to become oriented in the direction of the leader, in coordination with the command inputted via operating unit 22 of the leader (step S72).

After that, the user turns the orientation change button (i.e., input unit 12) displayed on display 14 OFF (step S73).

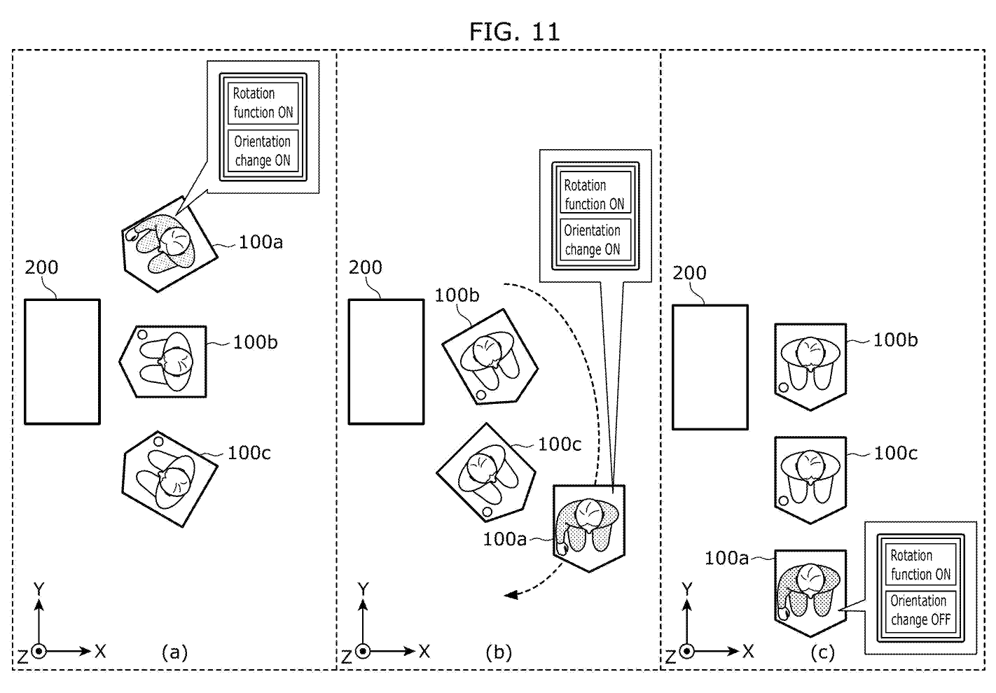

FIG. 11 is a schematic diagram showing examples of detailed movements in S71 to S73 shown in FIG. 10. The figure shows still another example operation to reorganize a formation that has entered the art museum in the positive direction along the Y axis into a new formation for exiting the art museum in the opposite direction (the negative direction along the Y axis) after appreciation. (a) of FIG. 11 is a schematic diagram when the user turns the orientation change button displayed on display 14 ON after the state shown in (c) of FIG. 4. (b) of FIG. 11 is a schematic diagram showing that mobile bodies 100b and 100c rotate in coordination with mobile body 100a moving to the other position. (c) of FIG. 11 is a schematic diagram when the user turns the orientation change button displayed on display 14 OFF. It should be noted that since the movements of mobile bodies 100a to 100c subsequent to (c) of FIG. 11 are the same as the movements subsequent to (b) of FIG. 9B, the description thereof is omitted.

First, as shown in (a) of FIG. 11, the user switches orientation change OFF to orientation change ON. For example, by pressing the orientation change button (i.e., input unit 12) displayed on display 14, the user switches orientation change OFF to orientation change ON. It should be noted that an operation to switch orientation change OFF to orientation change ON may be performed by the user riding the leader or a user riding none of the mobile bodies and located at a remote place.

Next, as shown in (b) of FIG. 11, by inputting a command via operating unit 22, the user riding mobile body 100a causes mobile body 100a to move to the end position in the new formation. Then, mobile bodies 100b and 100c rotate (e.g., perform a pivot turn operation) in coordination with the command inputted via operating unit 22 of mobile body 100a. Specifically, main body 25 commands mobile bodies 100b and 100c to rotate to become oriented in the direction of mobile body 100a. Rotation angles of mobile bodies 100b and 100c are determined using the position information about mobile bodies 100a to 100c described in (a) of FIG. 7B.

Finally, as shown in (c) of FIG. 11, the user switches orientation change ON to orientation change OFF. By pressing the orientation change button (i.e., input unit 12) displayed on display 14, the user switches orientation change ON to orientation change OFF. This operation causes mobile bodies 100b and 100c to stop rotating to become oriented in the direction of the nose of mobile body 100a.

Accordingly, in the formation reorganization, controller 25a1 makes it possible to perform orientation change control by causing all the followers included in the formation to become oriented in the direction of the leader that has moved to the other position. For this reason, a more efficient change of the direction of travel of the mobile bodies is achieved without the users commanding the followers.

Additionally, controller 25a1 makes it possible to perform the orientation change control on all the followers in coordination with the leader moving from the lead position to the end position in the new formation in the formation reorganization. For this reason, a more efficient change of the direction of travel of the mobile bodies is achieved without the users commanding the followers.

Although the control device, the mobile body, the control method, and the program have been described above based on the embodiment, the present disclosure is not limited to the embodiment. Forms obtained by making various modifications to the present embodiment and the variations that can be conceived by a person skilled in the art or forms achieved by combining some of the constituent elements in the embodiment are included in the scope of the present disclosure, as long as they do not depart from the essence of the present disclosure.

For example, although controller 25a1 of control device 25a etc. includes a processor, controller 25a1 may be implemented by a dedicated electronic circuit such a gate array (GA).

In addition, a program may be stored in a non-transitory computer-readable recording medium such as a DVD and distributed.

### INDUSTRIAL APPLICABILITY

The present disclosure is applicable as a control device, a mobile body, a control method, and a program, for example, as a robotic mobile body, that allow a plurality of mobile bodies to reorganize a formation while traveling.

1. A control device that controls traveling of a first mobile body, the control device comprising:
a storage that stores formation information indicating whether the first mobile body is a leader or a follower, the leader being a lead mobile body among a plurality of mobile bodies traveling in a formation, the follower being a subsequent mobile body other than the lead mobile body among the plurality of mobile bodies traveling in the formation; and
a controller that controls traveling of the first mobile body in a travel mode according to the formation information stored in the storage, the travel mode including a convoy mode and a rotation mode,
wherein the convoy mode is a travel mode in which the plurality of mobile bodies travel in a formation,
the rotation mode is a travel mode that permits the leader to perform any of a plurality of types of traveling and permits the follower to perform only a rotation among the plurality of types of traveling, and
when the formation information indicates that the first mobile body is the leader, the controller performs formation reorganization by causing all followers included in a formation to form, after the first mobile body moves from a lead position in the formation to an other position, a new formation in which the first mobile body that has moved to the other position is a new lead mobile body.

2. The control device according to claim 1,
wherein the controller performs the formation reorganization in the rotation mode.

3. The control device according to claim 1,
wherein the other position is an end position in the new formation.

4. The control device according to claim 1,
wherein in the formation reorganization, the controller performs orientation change control by causing all the followers included in the formation to become oriented in a direction of the first mobile body that has moved to the other position.

5. The control device according to claim 4,
wherein in the orientation change control, all the followers included in the formation become oriented in the direction of the first mobile body that has moved to the other position, by rotating by a predetermined angle.

6. The control device according to claim 4,
wherein in the orientation change control, all the followers included in the formation become oriented in the direction of the first mobile body that has moved to the other position, by rotating by an angle notified by the first mobile body.

7. The control device according to claim 4,
wherein the controller performs the orientation change control in coordination with the first mobile body moving from the lead position in the formation to the other position in the formation reorganization.

8. The control device according to claim 4,
wherein in the orientation change control, all the followers included in the formation become oriented in the direction of the first mobile body that has moved to the other position, by detecting a position of the first mobile body that has moved to the other position.

9. A mobile body comprising the control device according to claim 1.

10. A control method for controlling traveling of a first mobile body, the control method comprising:
reading out formation information from a storage, the formation information indicating whether the first mobile body is a leader or a follower, the leader being a lead mobile body among a plurality of mobile bodies traveling in a formation, the follower being a subsequent mobile body other than the lead mobile body among the plurality of mobile bodies traveling in the formation; and
controlling traveling of the first mobile body in a travel mode according to the formation information read out, the travel mode including a convoy mode and a rotation mode,
wherein the convoy mode is a travel mode in which the plurality of mobile bodies travel in a formation,
the rotation mode is a travel mode that permits the leader to perform any of a plurality of types of traveling and permits the follower to perform only a rotation among the plurality of types of traveling, and
in the controlling, when the formation information indicates that the first mobile body is the leader, formation reorganization is performed by causing all followers included in a formation to form, after the first mobile body moves from a lead position in the formation to an other position, a new formation in which the first mobile body that has moved to the other position is a new lead mobile body.

11. A non-transitory computer-readable recording medium having recorded thereon a computer program for causing a computer to execute the control method according to claim 10.
